(19) United States
(12) Patent Application Publication
(10) Pub. No.: US 2010/0064047 A1
(43) Pub. Date: Mar. 11, 2010

(54) INTERNET LOOKUP ENGINE

(76) Inventor: Alan T. Sullivan, Leesburg, VA (US)

Correspondence Address: LATIMER & MAYBERRY IP LAW, LLP, 13873 PARK CENTER ROAD, SUITE 106, HERNDON, VA, 20171, US

(21) Appl. No.: 12/529,982

(22) PCT Filed: Mar. 5, 2008
(86) PCT No.: PCT/US2008/055841

§ 371 Date: Sep. 4, 2009

Related U.S. Application Data
(60) Provisional application No. 60/892,915, filed on Mar. 5, 2007.

(51) Int. Cl. G06F 15/16

(52) U.S. Cl. 709/228

(57) ABSTRACT

The present invention provides computer software, hardware, and systems for use as, or as part of, an Internet lookup engine that eliminates the need for initial consultation with the DNS system. The software of the invention enables client applications (e.g., web browsers, email clients, etc.) to make a persistent or apparent session-level connection with the Internet lookup engine, and may be part of the Internet lookup engine, an API, plug-in, and/or add-on. Information about a client application (collected from previous sessions) may be applied to each new session to create permanence or apparent permanence for the user from session to session. Methods of doing business are also disclosed using the principles of the present invention.

### CROSS-REFERENCE TO RELATED APPLICATIONS

This application relies on the disclosure of, and claims the benefit of the filing date of, U.S. provisional patent application No. 60/892,915, filed 5 Mar. 2007, the entire disclosure of which is hereby incorporated herein by reference.

### BACKGROUND OF THE INVENTION

1. Field of the Invention

The present invention relates to computer programs, hardware, and systems for communication over the Internet. More specifically, the invention relates to an engine for persistent connection between a client application and a node on the Internet.

2. Description of Related Art

The Internet is a global network of individual computers linked to each other by domain name servers (DNS). The DNS is an (application-level) distributed database where individual computers act as clients requesting services of one or more DNS servers. In this global network, each individual computer is assigned an address called an Internet Protocol Address or IP Address. The IP Address of each computer in the network is stored in one or more DNS. The IP Address is provided by the DNS to other computers in response to queries searching for the IP Address. The IP Address of a target computer allows the requesting computer to make contact with the target computer. Typically, computer users do not know the actual IP Address of the computer they wish to contact. Rather, they know the name, in a human language, of the web page or e-mail address they wish to contact. Therefore, they cannot connect directly to the computer of interest, but must rely on the DNS system to provide them with the correct IP Address in order to make a connection to the target computer.

FIG. 1 illustrates a simplified flow chart of the DNS lookup process. For example, a user types into an Internet browser resident on a requesting computer a lookup in the form of a Uniform Resource Locator (URL; e.g., http://www(dot)paxfire(dot)com). Typically, the URL comprises a protocol type (e.g., http), a domain name (e.g., paxfire.com), and in some cases, other identifying information, such as keywords, etc. Assuming a mapping is not already present in the computer's local cache, the browser (or a resolver) translates the URL into a DNS request to be sent to a domain name server (typically located at the user's Internet Service Provider (ISP)). The requesting computer then sends the domain name (e.g., “paxfire.com” obtained from the URL) to the DNS in the form of a DNS query message. The query message requests the DNS to find the corresponding IP address and send it in a response message. The query message contains header data and a message portion containing the domain name. In other words, the query and response messages only submit the domain name in the request and do not include any other user-specific or application-specific information regarding the lookup. DNS query and response messages may use either TCP or UDP, to provide “connection-oriented” or “connectionless” transmission, respectively. However, the DNS system primarily uses “connectionless” UDP transmission for speed and efficiency purposes (since establishing reliable connections with TCP tends to slow down the lookup process). At the same time, UDP-based DNS messages are limited to e.g., 512 kilobytes, which reduces the amount of information that can be transmitted in the request and response messages.

If the ISP DNS knows the corresponding IP Address of the query, it returns the information to the requesting computer, and a connection may be initiated with the target computer. If it does not know the information, it makes a request to a Root DNS to provide information on the requested IP Address. If the Root DNS knows the requested IP Address, it provides the ISP DNS with the Address, which supplies it to the requesting computer. If the Root DNS does not know the requested IP Address, the Root DNS provides the ISP DNS with the addresses of other DNS servers that maintain lists of all IP Addresses associated with the requested IP Address (e.g., all addresses that include .com, .gov, .biz, net, etc.). These domain name servers are referred to as Registry (or top-level or first-level) DNS. The ISP DNS then contacts one or more first level, or Registry, DNS to request the IP Address. If the requested IP Address exists, the Registry DNS returns the IP Address of a DNS that knows the requested IP Address. If the requested IP Address does not exist, the Registry DNS informs the ISP DNS that the request was unresolved, and the DNS passes this information back to the requesting computer. The ISP DNS then contacts the DNS that knows the requested IP Address, and asks for the IP Address. The second level DNS forwards the IP Address to the ISP DNS, and it passes the IP Address down to the requesting computer, so that a connection may be made with the target computer.

One key drawback of the DNS system is that it is a distributed system of servers typically spanning over a Wide Area Network (WAN). If a request is unknown to the ISP DNS, for example, it is sent to a root DNS server, then to a first level server, then a second level server, and so on, thus consuming a considerable amount of network resources and bandwidth. In addition, because the servers are widely distributed, DNS query requests are primarily UDP-based for speed and efficiency purposes. However, UDP is an inherently connectionless protocol. Therefore after a DNS server responds to a request, it retains no user-specific information (such as IP Address of the requestor). If the requestor is an ISP DNS, the only user-specific information available to the DNS is the IP Address of the ISP. In addition, DNS request messages typically do not take full advantage of application-specific information such as protocol type (HTTP, SMTP, FTP, etc.), keywords, etc. available from the URL entered in the browser. This is in part because of the limited size of the DNS messages allowed by the DNS protocol (e.g., 512 bytes) and the limited abilities of widely distributed DNS servers to manage all this information. As a result, DNS servers do not manage additional information (e.g., protocol, keywords, etc.) entered by users in the browser. In addition, DNS servers are not able to offer persistent connections or an apparent persistent connection with client applications to provide faster and/or context-relevant lookup results.

As a result of these deficiencies, many websites often deposit “cookies” on a client computer to provide some form of “statefulness” to previous user requests. However, cookies have their own set of drawbacks. For example, transmittal of cookies across the Internet only adds to network traffic, thereby reducing bandwidth even further. Moreover, cookies are susceptible to various types of security attacks such as cookie theft, cookie poisoning, cross-site cooking, etc. For example, cookies may contain sensitive information (such as user names or tokens) that may be readily obtained by techniques such as packet sniffing, and the like. Furthermore, cookies are only used for a specific host/domain name. That is, cookies are only exchanged between the site that has set them and the user's browser.

In view of the above shortcomings, the inventor has recognized that there remains a need to provide a persistent connection between a client application and a node that is able to provide IP Addresses in response to a user lookup. In addition, the inventor has also recognized that there also remains a need to provide faster, context-relevant results in response to lookups based on additional provided information such as protocol type, keywords, hotwords, time of request, and/or domain name. Moreover, the inventor has further recognized that there also remains a need to reduce the amount of unnecessary network traffic, and to address security issues, associated with the DNS system.

### SUMMARY OF THE INVENTION

The present invention provides a solution to the shortcomings of the DNS system for IP address lookup on the Internet. The invention provides software, hardware, and systems that provide an enhanced Internet experience for users by eliminating the need for initial consultation with the DNS system for look up of websites and other information on the Internet. In essence, the invention provides a way for client applications, such as web browsers, e-mail clients, etc. to make a persistent session level connection with an Internet lookup engine (ILE).

In one aspect, the invention provides computer software that enables an Internet user to make a persistent session level connection to an Internet lookup engine. In some embodiments, the software comprises at least part of an Internet lookup engine, application programming interface (API), plug-in and/or add-on. Some of the software for the Internet lookup engine may be found, for example, in the lookup engines of co-pending U.S. patent application Ser. No. 10/837,614, co-pending U.S. patent application Ser. No. 11/019,369, co-pending U.S. patent application Ser. No. 11/224,681, and/or co-pending U.S. patent application Ser. No. 11/328,457, the entire disclosures of all of which are hereby incorporated herein by reference. In general, the software comprises instructions for carrying out method steps of the invention.

According to an exemplary method of the present invention, the client application establishes a persistent connection with the Internet lookup engine using, for example, an API, plug-in, and/or add-on, etc. For example, an API may be implemented on requesting computer to communicate between a browser (or resolver), resident on the computer, and the Internet lookup engine. Once a connection is established, any lookups entered by a user into the browser are passed to the Internet lookup engine instead of the DNS system. In other words, instead of making DNS lookup requests, the requesting computer submits lookup requests to the Internet lookup engine e.g. via the API. The API may obtain additional application-specific or user-specific information from the lookup entered in the browser such as protocol type (e.g., HTTP, SMTP, FTP, etc.), keywords, hotwords, etc. in addition to domain name. The API then sends the information to the Internet lookup engine, which makes a determination as to whether or not it is necessary to pass the request on to the DNS system. For example, when a lookup request is received, the Internet lookup engine looks to see if it already has the desired mapping. If it does have the mapping, it sends the IP address back to the requesting computer. According to a further method step, the Internet lookup engine may also make a determination as to whether the lookup is relevant. If the lookup is not relevant (e.g., due to undesirable keywords, protocols or domain names), then the Internet lookup engine may filter out the request, thereby reducing unwanted network traffic. Optionally, the Internet lookup engine may return an error message to the application and/or redirect the application to another page. If the lookup is relevant (but a mapping is not present), the Internet lookup engine may look to see if it has any other user-specific or application-specific information about the request from which to synthesize a result page. If sufficient information needed to make a mapping is not available, then the Internet lookup engine may then send the lookup to the DNS system according to conventional techniques.

In another aspect, the invention provides computer hardware that works in conjunction with the software of the present invention. The hardware can be any type of computer hardware known in the art, but is preferably hardware that comprises at least one processor capable of executing the software of the invention. In preferred embodiments, the hardware may comprise an Internet appliance as disclosed in co-pending U.S. patent application Ser. No. 10/837,614, co-pending U.S. patent application Ser. No. 11/019,369, co-pending U.S. patent application Ser. No. 11/224,681, and/or co-pending U.S. patent application Ser. No. 11/328,457, the entire disclosures of all of which are hereby incorporated herein by reference.

In embodiments, the Internet lookup engine may include a plurality of functional modules that may be implemented in one or more processors. It is to be understood that the hardware of the invention is not, however, limited to processors, but can be any hardware that comprises a processor, including, but not limited to, personal computers, network servers, permanent or removable cards, hand-held devices, mobile phones, and the like. The functional modules include, but are not limited to: a cache module for storing information obtained from a persistent connection with an application (e.g., browser); a database module comprising one or more databases for storing previously obtained user-specific or application-specific data; and a filter module comprising one or more application-level filters for filtering different user requests based on predetermined rules. The filters can be turned on and off at the application level and can be configured for filtering phishing sites, providing parental controls, reducing spam, authenticating hosts, etc. Other rules could assign ports to a certain protocol (e.g., Port 80=HTTP), and so forth. In general, any type of information of interest to the user may be filtered. Optionally, the Internet lookup engine may also comprise a Domain lookup engine (DLE) that performs mappings between domain names and IP Addresses, and an additional services module (for example for communicating with other content providers). Preferably, the Internet lookup engine is disposed between a requesting computer and a domain name server, however the location of the Internet lookup engine may vary depending upon the particular implementation. Improved security may be provided by the present invention because lookups are not passed up and down the DNS infrastructure, but are rather managed by the Internet lookup engine. Thus, problems associated with cookies, among other things, are reduced. In embodiments, the Internet lookup engine may also be located between the requesting computer and an ISP, or at the ISP level.

In an additional aspect, the invention provides systems comprising hardware and software. The systems of the invention provide an Internet user the ability to make a session level connection to an Internet lookup engine, and reduce or eliminate the need for the user to rely on the DNS system to make connections to sites of interest on the Internet. In addition to the Internet lookup engine, the systems may encompass other entities, such as advertisers, content provider(s), and/or one or more Internet Service Provider (ISP) servers, and the like. In embodiments, the systems may optionally comprise one or more DNS servers.

In a further aspect, the invention provides methods of doing business over the Internet using a computer. In general, the methods of doing business comprise optionally providing software, hardware, and/or systems according to the present invention, controlling, at least to some extent, Internet traffic, and generating revenue by directing Internet traffic to an IP Address of a landing page. Such landing pages may comprise content for which one or more entity has paid money to have included in the landing page or for which money is earned by the landing page provider when a user accesses information provided on the landing page.

### BRIEF DESCRIPTION OF THE DRAWINGS

FIG. 1 is a flowchart depicting a typical lookup request using the conventional DNS system.

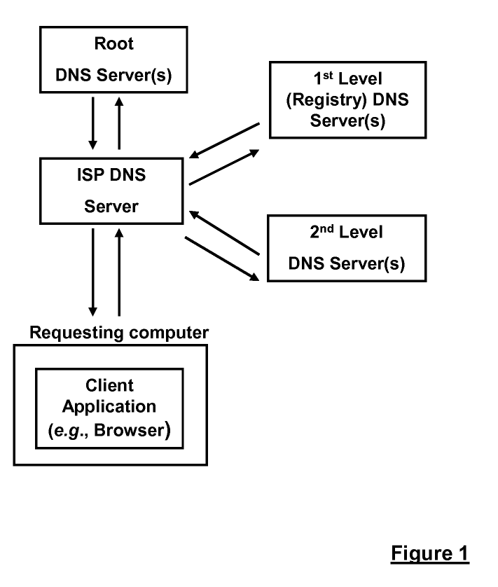

FIG. 2 is a flowchart illustrating a lookup according an exemplary embodiment of the present invention.

FIG. 3 is a block diagram illustrating functional components of the Internet lookup engine according to an exemplary embodiment of the present invention.

FIG. 4 is a block diagram illustrating various system components according to an exemplary embodiment of the present invention.

### DETAILED DESCRIPTION OF VARIOUS EXEMPLARY EMBODIMENTS OF THE INVENTION

Reference will now be made in detail to various exemplary embodiments of the invention. The following detailed description is provided to better illustrate certain details of aspects of the invention, and should not be interpreted as a limitation on the scope or content of the invention.

The DNS system is the standard way that all computers on the Internet look up domain names to find out what the IP address is. Most URLs make use of domain names to describe the host part of the address. However, the DNS system has a number of shortcomings, including not maintaining application-specific or user-specific information about the lookup. The present invention provides a way for applications (such as web browsers, e-mail clients, and the like) to make a session level connection for an Internet lookup engine. In general, the Internet lookup engine of the present invention creates a persistent session-level connection with the client application. For example, information about a client (collected from previous sessions) may be applied to each new session to create permanence or apparent permanence for the user from session to session. The Internet lookup engine can also allow the session to maintain a navigation history to better serve up web content, etc. Advantages of embodiments of this invention over the prior art are numerous, and include allowing a browser to maintain session level permanence without the need for cookies (although cookies may be a part of the mode of operation of the engine), and allowing application-specific requests (the lookup engine allows web browser to send keywords, complete URLS, etc) instead of looking up just the host IP address. As mentioned, one exemplary advantage is that keywords could make use of search engines to further enhance the web lookup experience at the browser. In embodiments where cookies are eliminated, information equivalent to or superseding the information typically in cookies can be maintained on the API. In such cases, the API will contain more information than just a URL, and can access the information as needed to provide session-level permanence (or apparent permanence).

According to one aspect, the present invention provides computer software that enables a client application, such as a browser, to make a session level connection to the Internet lookup engine. For example, the present invention may include software for the Internet lookup engine and an API (or plug-in, add-on, etc.) that enables client applications to connect to the Internet lookup engine. In some configurations, the Internet lookup engine comprises software, or a suite of software, that is capable of providing IP Addresses of sites of interest, based on various lookup terms provided by a user. According to a preferred embodiment, the lookup engine does not initially consult the DNS system to obtain IP Addresses of interest, but rather comprises a database and/or cache of known IP addresses that correspond to queries of interest typed into a browser search bar by a user. The Internet lookup engine may however, when an IP address is not known, rely on the DNS system for resolution of an IP address based on a query. Typically, though, the Internet lookup engine will archive user-specific or application-specific information related to requests in one or more databases and use it at some later date, thus eliminating the need to rely on the DNS system to resolve the IP address. In general, the software comprises instructions for carrying out the method steps of the invention in a computer context.

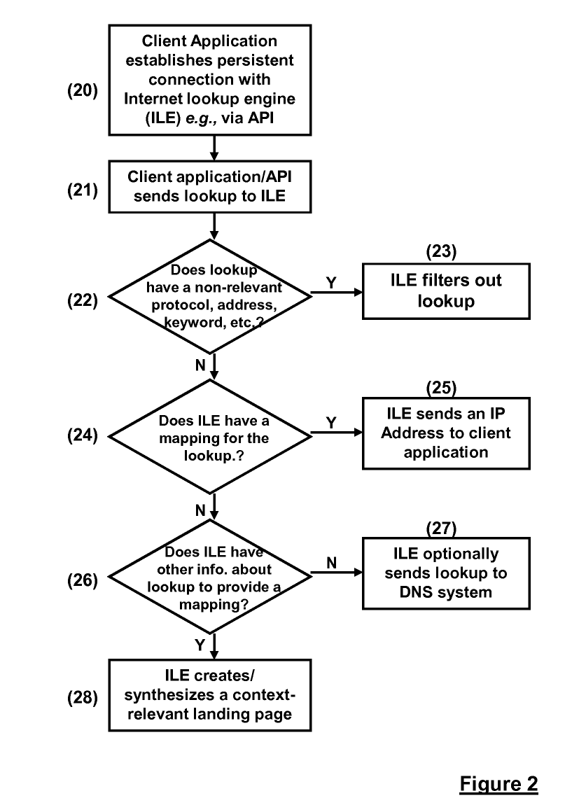

FIG. 2 illustrates method steps that may be performed by the software of the present invention according to an exemplary embodiment. The method steps may be performed by one or more pieces of software. For example, some of the method steps may be performed by the Internet lookup engine and some steps performed by an API implemented on the requesting computer. Alternatively, all of the method steps may be performed by the Internet lookup engine. As shown in step 20, the client application (e.g., browser, mail client, or the like) on the requesting computer establishes a persistent connection with the Internet lookup engine. The software of the present invention is able to perform at several layers of the OSI model, including layers 2-4, as well as the upper layers. The connection has session-to-session permanence in that each user, or more specifically, each machine or group of machines funneling through an IP address, will be recognized by the software and systems of the present invention based on various identifying information, such as IP address, MAC address, and the like. For example, information about that user, collected from prior sessions, may be applied to each new session to create a permanence, or an apparent permanence, for the user from session to session. To achieve this, the system of the invention (described in more detail below) includes at least one or more databases, which analyze and/or correlate information about particular client applications (or machines) and their previous searches, preferred Internet sites, keywords, hotwords, etc. and intended sites to visit, etc. The software and system of the invention consult the database(s) to provide the user with an enhanced Internet experience.

After a persistent or apparent persistent session connection is established in step 20, the client application (e.g., via an API) submits lookup requests to the Internet lookup engine instead of the DNS system (as shown in step 21). The information provided in the lookup request may include the domain name as well as other information from the URL such as protocol, keywords, headers, meta data, etc. Moreover, additional information may also be provided such as time of request, user IP Address, MAC address, and so forth. In step 22, the Internet lookup engine may look at other information submitted with the request, such as keywords, hotwords, and protocol type (e.g., HTTP, SMTP, FTP, etc.) to determine if it is a relevant request. For example, non-relevant requests may contain information that is not of interest, and thus should be filtered out so as not to tie up system resources. For example, some entities may want to analyze, capture, and/or redirect only web page queries (i.e., HTTP queries), and thus will not want to process e-mail queries (i.e., SMTP queries). The systems and methods of the invention permit such an entity to filter the SMTP queries, allowing them to either pass through unprocessed or be returned to the sender with an error message to the effect that the query was an unresolved request. Of course, a plethora of other parameters may be used by each individual entity to define relevancy. If the lookup is not relevant, then the Internet lookup engine may filter the request (step 23), return an error message to the application, and/or redirect the application to a context-relevant landing page.

In step 24, the Internet lookup engine consults its cache to see if it has a mapping for the request. If a mapping is found, the lookup engine returns the corresponding IP Address to the client application (e.g., browser) in step 25. If the Internet lookup engine does not have a mapping for the request in step 24, it determines whether it has other information about the request in step 26. For example, in addition to domain name lookups, the Internet lookup engine may receive other lookup information such as complete URLs, protocol type, keywords, and/or hotwords, etc. In step 26, the Internet lookup engine consults its database(s) to see if it has any other user-specific or application-specific information. For example, in such a system or method, the Internet lookup engine may continuously collect information and statistics about previous DNS requests, thus building a database for the system and method. If sufficient information to provide a mapping is not available, the Internet lookup engine may then pass the lookup on to the DNS system in step 27. If context-relevant user-specific or application-specific information is available in the database(s), the Internet lookup engine may synthesize or create a context-relevant result page as depicted in step 28.

The software of the present invention comprises instructions for executing the above method steps within a computer context. The software can be written in any language (e.g., C, C⁺⁺) for execution on any platform (e.g., Windows, Mac, Linux/UNIX). It can comprise a single file or a suite of files that can run independently or in an integrated fashion. The software may also be provided in multiple copies, for example for redundancy), and/or portions of the software may reside on different computers, but act in a concerted fashion to achieve the functions described herein.

In embodiments, the software includes an API that enables an application, such as an Internet browser, to make a persistent connection with the Internet lookup engine. The connection has session-to-session permanence in that each user, or more specifically, each machine or group of machines funneling through an IP address, will be recognized by the software and system based on various identifying information (such as IP address, MAC address, and the like). The API may be resident, partially or wholly, on a local computer, such as a user's computer hard drive. Alternatively, the API may be resident, partially or wholly, on a network computer, such as server for a group of users. In embodiments, the API may be resident on a server or server-like appliance that sits within a network, such as within a network administered by an ISP. In addition, the API can be integrated with an Internet appliance, such as those provided by Paxfire, Inc. (Sterling, Va.). In these situations, the API can be a software module running within the Internet appliance or can be a stand-alone piece of software (e.g., resident on a separate piece of hardware), that functionally interacts with and/or complements the Internet appliance. For example, the software may be present on the Internet appliance and function in conjunction with other features of the appliance to provide the functions generally discussed herein. Additionally or alternatively, the software may be a plug-in or add-on for e.g., a browser, which enables the browser to connect to an Internet lookup engine. It thus can be resident on a user's local computer. In embodiments, the software is provided as an integral part of a browser. In this regard, any browser may comprise the software, including, but not limited to Mozilla Firefox™, Netscape™, or Internet Explorer™. The invention is not limited by the type of browser, but instead may be integrated or included with any suitable browser as a plug-in, add-on, or the like.

In a related aspect, the software and systems of the invention further provide one or more database(s) comprising e.g., query-specific, user-specific and/or application-specific information. As a result, users are able to make a persistent connection to an Internet lookup engine without an initial routing through the DNS system. Information about that client application (or machine), collected from prior sessions, may be applied to each new session to create a permanence, or an apparent permanence, for the user from session to session. To achieve this, the invention includes one or more databases, which contain information about particular users (or machines) and their previous searches, preferred sites to visit, correlations between keywords, hotwords, etc. and intended sites to visit, etc. Thus, the software and system of the invention consults the database to provide the user with an enhanced Internet experience.

In another aspect, the invention provides computer hardware that works in conjunction with the software of the present invention. In general, the hardware comprises at least one processor that can execute the software of the invention. It is to be understood that the hardware of the invention is not, however, limited to processors, but can be any hardware that comprises a processor, including, but not limited to, personal computers, network servers, permanent or removable cards, hand-held devices, mobile phones, and the like. In preferred embodiments, the hardware comprises an Internet appliance or lookup engine, such as, but not limited to, those from Paxfire, Inc. (Herndon, Va.).

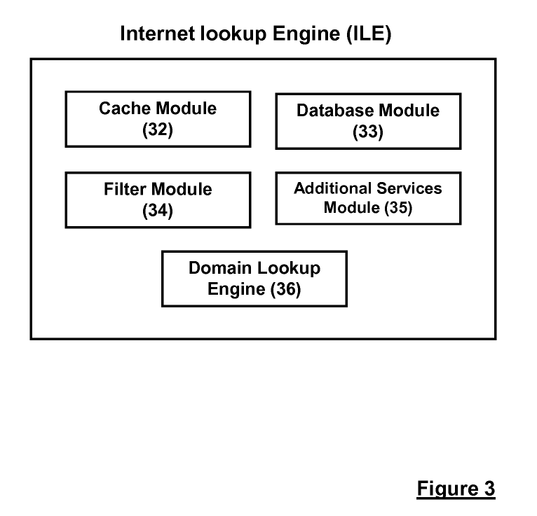

FIG. 3 illustrates various functional modules within the Internet lookup engine according to a preferred embodiment. The functional modules include: a cache module 32, a database module 33, and a filter module 34. Optionally, the Internet lookup engine may also comprise a Domain Lookup Engine (DLE) 36 that provides domain name to IP Address mapping and an additional services module 35 (e.g., for communicating with other content providers). The cache module 32 serves to store information obtained from a persistent connection with an application. The database module 33 may contain one or more databases configured to store previously obtained mappings and perform statistical analysis and/or correlations to provide navigational history, intended sites to visit, etc. In addition to domain names and IP Addresses, the cache module 32 and/or database module 33 are adapted to store other application-specific information. Such information may include complete URLs, protocol type, keywords, hotwords, user IP Address or MAC address, and/or time of request, etc. Thus, data previously stored in the database module 33 may be applied to create session permanence or apparent session permanence for a user from session to session.

Additionally, the database module 33 may also store information regarding invalid or outdated mappings. This may be useful in the sense that the client application can be notified (or redirected) immediately if a web site does not exist, for example, before sending an invalid request on to DNS servers (thereby wasting network resources and bandwidth). For example, when an unresolvable query is sent to the DNS system, it is passed up and down the Internet infrastructure in an attempt to resolve the requested IP Address, and it is only after all appropriate DNS servers have been contacted that an error message is returned to the requester. Thus, the present systems and methods provide for caching of erroneous queries and permit not only content-relevant redirection, but allow for a substantial decrease in the amount of time and resources required for redirection of the unresolvable query using the DNS system.

The filter module 34 provides e.g., application-level filters capable of filtering requests based on predetermined rules for different users. The filters can be turned on and off at the application level and may be configured for filtering phishing sites, providing parental controls, reducing spam, authenticating hosts, etc. In addition, the filter module 34 may also be configured to filter out certain requests by users based on e.g., non relevant protocols or keywords. For example, the filter module 34 may be configured to accept HTTP queries, and to filter out SMTP queries (rules could be applied to associate protocols with certain ports (e.g., Port 80=HTTP), and so forth). Optionally, the Internet lookup engine may also comprise a Domain lookup engine (DLE) that performs mappings between domain names and IP Addresses. The Internet lookup engine may comprise an Internet Appliance as disclosed, for example, in co-pending U.S. patent application Ser. No. 10/837,614, co-pending U.S. patent application Ser. No. 11/019,369, co-pending U.S. patent application Ser. No. 11/224,681, and/or co-pending U.S. patent application Ser. No. 11/328,457, the entire disclosures of all of which are hereby incorporated herein by reference. It is further contemplated that the Internet lookup engine may comprise additional functional modules, and therefore should not be limited to the modules depicted in FIG. 3.

Where hardware comprises multiple elements, the hardware may be connected by any known means. In preferred embodiments, the hardware comprises a processor and also comprises the software of the invention, present either on a long-term storage medium, such as a hard drive, or on a short-term storage medium, such as random access memory (RAM). Electronic components and connections used in the engines of the present invention are those typically used in the computer industry, as are all other structural elements of the systems. The electronic components can be physically connected via cables, wires, or the like. Connections may be direct (i.e., from one to the other without any intervening hardware, except via the connector) or indirect (i.e., through one or more other hardware devices, such as circuit boards, filters, etc.). In other embodiments, the connections are not necessarily physical connections (e.g., connections via electromagnetic energy, such as infrared signals, radio signals, microwave signals, optical signals, and the like).

In addition, the hardware and software of the present invention can work at various layers (i.e., corresponding to the OSI model), receiving, processing, and sending information as packets of bits of information. In some embodiments, hardware and software of the invention (e.g., in the form of an API), is linked to the Internet lookup engine at one or more of these layers, including Layer 2 (the data link layer). In embodiments, such as those where the hardware and software function at Layer 2, they are faster than systems currently in use, and permit pattern matching without having to go up and down the various layers of the internet architecture.

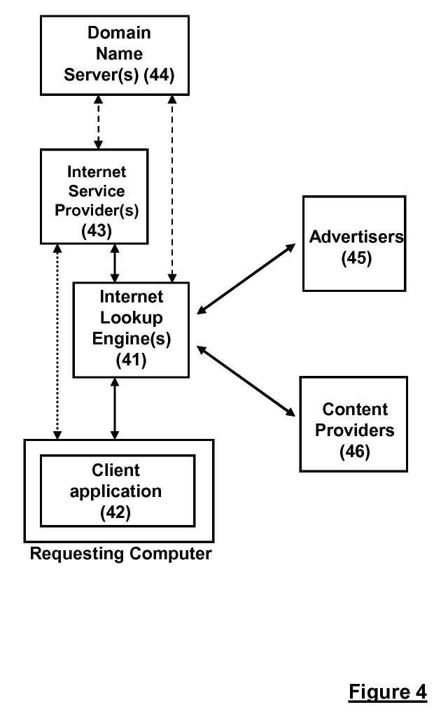

In yet another aspect, the invention provides systems comprising the hardware and software of the invention. The systems of the invention provide a user the ability to make a session level connection to an Internet lookup engine, and reduce or eliminate the need to rely on DNS servers to make connections to sites of interest on the Internet. In general, the system comprises at least one client computer connected to a network such as the Internet, and may additionally comprise one or more other pieces of software and/or hardware. FIG. 4 illustrates an exemplary embodiment of system components contemplated by the present invention. As shown in FIG. 4, the system comprises a user computer 42 in communication with an Internet lookup engine 41, which may be in communication with other Internet lookup engines 41 and/or one or more an ISP server(s) 43. In further embodiments, the system may further comprise other components, such as advertisers 45, content providers 46, and the like. The system may also comprise a plurality of remote and/or local Internet lookup engines 41 in communication with one another for sharing of information. In some embodiments, the system optionally comprises one or more DNS servers 44 (as depicted by dashed lines), which may be consulted for resolution of an IP address when the system of the invention does not have adequate information in one or more databases to provide a desired IP address for a user's query.

In addition, FIG. 4 also shows a process whereby a requesting computer has implemented the API of the present invention and has the option to use the services provided by the Internet lookup engine. The client may also opt-out (depicted by the dotted line) and as a result, reverts to lookup requests via the conventional DNS system. In addition, the opt-in/opt-out function may be applied for certain types of queries, but not for others. For example, the user may opt-in for URL lookups, but opt-out for keyword or hotword lookups. The user could opt-in or opt-out by accessing a certain web page, contacting a system administrator, etc. In addition, the opt-in/opt-out status could also be managed by a network administrator for various users or groups or users, at various times, under various circumstances, etc.

In another aspect, the invention provides methods of doing business over the Internet using a computer. In general, the methods of doing business comprise providing software, hardware, and/or a system according to the present invention, and generating income through the use of that software, hardware, and/or system. Income may be generated through lease of the software, hardware, and/or system to an ISP or other interested party. Alternatively, income may be generated through control of traffic passing from users and an ISP, for example by selling advertising space on landing pages generated in response to queries submitted by the users. Additionally or alternatively, income may be generated through sale of advertising based on query terms, such as keywords and hotwords. Of course, income may be generated by selling keywords, hotwords, or other query types or specific queries to business entities or persons. For example, income may be generated by selling the rights to use a particular keyword or hotword as an indicator of a particular website (e.g., the word “car” may be purchased by an automobile manufacturer, and all queries for “car” will be sent to that manufacturer's website). Thus, in embodiments, the methods of doing business comprise controlling, at least to some extent, Internet traffic, and generating revenue by directing Internet traffic to a particular website, such as, but not limited to, a landing page comprising content for which one or more entity has paid money to have included in the landing page or for which money is earned by the landing page provider when a user accesses information provided on the landing page.

It will be apparent to those skilled in the art that various modifications and variations can be made in the practice of the present invention without departing from the scope or spirit of the invention. For example, the present systems and methods are suitable for use in a variety of Internet communication communications further including telephony, Instant Messaging (IM), e-mail, FTP, etc. Additionally, improved security may be provided by the present invention because lookups are not passed up and down the DNS infrastructure, but are rather managed by the Internet lookup engine. Thus, problems associated with cookies, among other things, are reduced. Other embodiments of the invention will be apparent to those skilled in the art from consideration of the specification and practice of the invention. It is intended that the specification and examples be considered as exemplary only, with a true scope and spirit of the invention being indicated by the following claims.

1. A system for providing session-level permanence to Internet communications, said system comprising:
computer software that allows a persistent session-level connection to an Internet lookup engine; and
computer hardware on which the software can be executed.

2. The system of claim 1, wherein the software comprises at least part of an Internet lookup engine, application programming interface (API), plug-in, or add-on.

3. The system of claim 2, further comprising at least one local computer,
wherein the API is implemented on the local computer to communicate between a browser resident on the computer and the Internet lookup engine.

4. The system of claim 3, wherein the API obtains application-specific or user-specific information from a lookup entered in an end-user application or server application.

5. The system of claim 4, wherein the information is protocol type, keywords, hotwords, or domain name of interest.

6. The system of claim 1, comprising a database of user-specific information for use in creating a session-level permanence or apparent permanence for the user.

7. Computer software comprising instructions for executing a method that enables a client application on a local computer to make a session-level connection to the Internet.

8. The software of claim 7, wherein the connection is made by way of an Internet lookup engine.

9. The software of claim 8, comprising instructions for accessing and using data relating to the local computer or users of the local computer.

10. The software of claim 8, wherein the software is capable of resolving requested IP Addresses without consultation with the DNS system of the Internet.
